(19) United States
(12) Patent Application Publication
(10) Pub. No.: US 2026/0252437 A1
(43) Pub. Date: Aug. 27, 2026

(54) PROGRAM ERROR DETECTION AND REMEDIATION

(71) Applicant: PAYPAL, INC., San Jose, CA (US)

(72) Inventors: Sudarson Vijayaragavan, Chennai (IN); Gokulash d v, Chennai (IN); Nikkila Prakash, Chennai (IN); Venkatesan Munusamy, Dharmapuri (IN); Senthil Nathan Rajan, Chennai (IN)

(21) Appl. No.: 19/064,356

(22) Filed: Feb. 26, 2025

(51) Int. Cl. G06F 11/07; G06F 8/70; G06F 9/48; G06F 9/50; G06F 11/3604

(52) U.S. Cl. CPC G06F 11/0793; G06F 11/0706

(57) ABSTRACT

A computer-implemented method includes receiving an indication of a runtime error respective of a computer program, scanning a codebase of the program to determine, based on the runtime error indication, a code location in the codebase related to the error, automatically generating, based on the indication and the determined code location, a prompt for a machine learning model, inputting the generated prompt to the machine learning model to cause the machine learning model to generate one or more recommended remediation actions, receiving, from the machine learning model, one or more remediation actions in response to the generated prompt, and causing at least one of the one or more remediation actions to be implemented in response to the indication of the runtime error.

### TECHNICAL FIELD

This disclosure relates to detection and remediation of errors in computer applications, including backend applications that provide services accessed by many frontend user systems.

### BACKGROUND

Applications occasionally enter an error state, due to unforeseen combinations of inputs that are not handled properly by the application code, due to an infrastructure or other hardware issue, etc. Errors are typically detected after they occur based on system performance changes and are resolved via a time-consuming manual review of the application code and error logs.

### BRIEF DESCRIPTION OF THE DRAWINGS

FIG. 1 is a block diagram view of an example system for monitoring for and resolving errors in executing applications.

FIG. 2 is a flow chart illustrating an example method of error remediation based on user identification of an error.

FIG. 3 is a flow chart illustrating example method of automated error monitoring and remediation.

FIG. 4 is a flow chart illustrating an example method of automated error monitoring.

FIG. 5 is a flow chart illustrating an example method of error remediation.

FIG. 6 is a block diagram of an example computing system.

### DETAILED DESCRIPTION

Applications that support backend services may process a large volume of computing actions in a short period of time. As a result, any downtime in a service application may impact a large number of users, and completely manual approaches to error detection and remediation may permit undesirable long downtimes of services and degraded computing system performance.

The instant disclosure provides numerous improvements to error detection and remediation. First, the instant disclosure provides approaches for automated detection of errors, including monitoring of system performance aspects to enable detection of errors before those errors occur, or before manual processes would discover those errors. Second, the instant disclosure provides approaches for automated remediation of errors, including both hardware-based and software-based solutions to errors. For example, automated error remediation may include automatic redirection or rebalancing of network traffic, automatic rebalancing of processing power, and/or automatic generation of corrected code for an application. As a result, error detection and remediation according to the present disclosure may improve the uptime and functionality of service applications and other applications. Automated error determination and remediation according to the present disclosure may reduce mean time to detect and mean time to recover with respect to runtime errors relative to existing approaches.

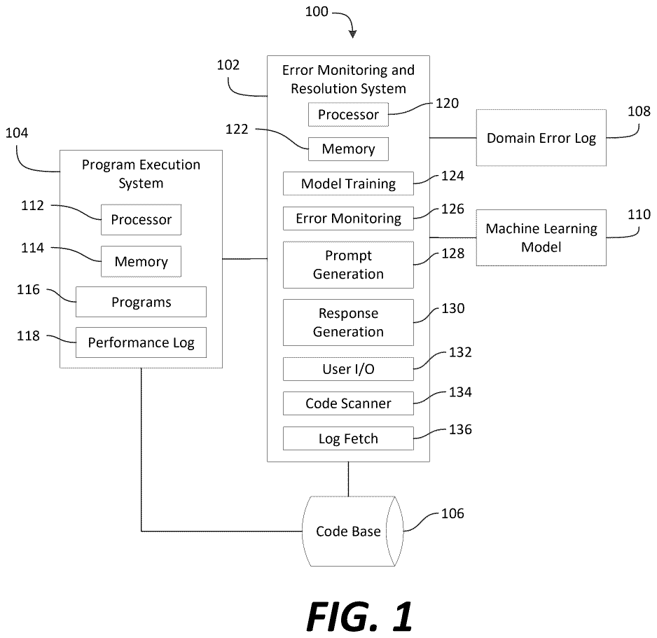

Referring to the drawings, wherein like numerals refer to the same or similar features in the various views, FIG. 1 is a block diagram view of an example system 100 for automated monitoring and remediation of application errors. The system 100 may include an error monitoring and resolution system 102 (which may be referred to herein as the error system 102), a program execution system 104, a code base 106, a domain error log 108, and a machine learning model 110.

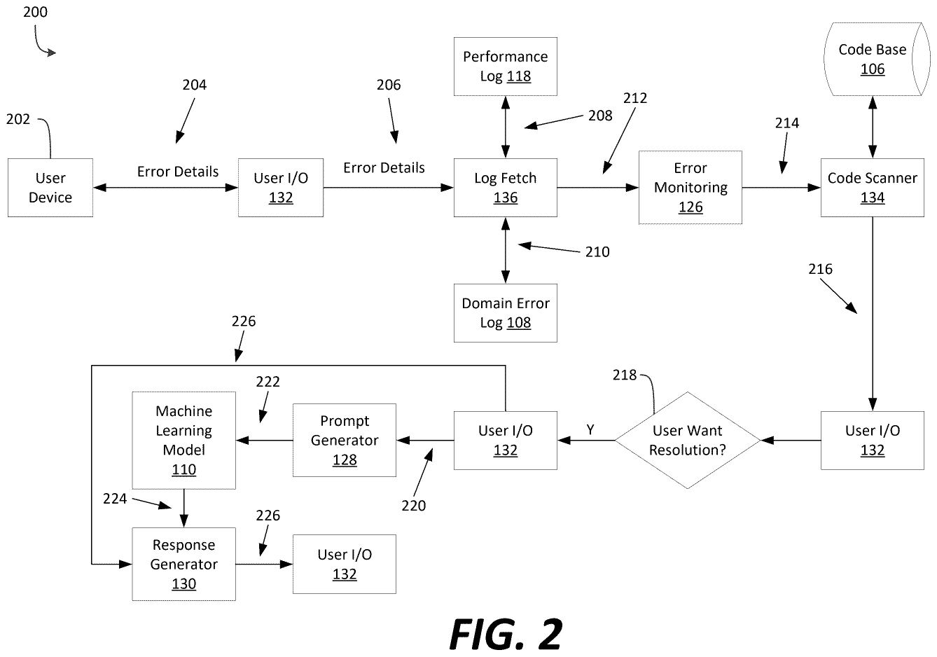

FIG. 1 illustrates and will be used to describe the functionality of different aspects of the system 100, and particularly the error monitoring and resolution system 102. After, FIGS. 2-5 will be utilized to describe the flow of information and processing within, and various modes of operation of, the system 100.

In general, the program execution system 104 may execute one or more application programs (which may be referred to herein interchangeably as programs and applications), including one or more back-end service applications. Accordingly, the program execution system 104 may be or may include one or more back-end servers or other computing devices involved in supporting a website mobile application interface or other user interface or program. The error monitoring and resolution system 102 they monitor the applications executed by the program execution system 104 in order to detect runtime errors in those applications and to resolve any detected errors. To do so, the error system 102 may utilize code base 106, the domain error log 108, and the machine learning model 110.

The program execution system 104 may include a processor 112 and a non-transitory, computer readable memory 114 storing instructions that, when executed by the processor 112, caused the program execution system to perform one or more methods, operations, etc. The program execution system 104 may store and execute one or more programs 116, and each of those programs may provide or support a service for use by one or more end user systems. Such services may include, for example, user interface provision, processing of user data, executing user instructed transactions or other user instructed computing actions, and the like.

The programs 116 may be executed within and may support services from a particular domain. The domain may be a top-level domain or a similar association of computing resources offered to end users via a common access channel. In some embodiments, the programs 116 may include both backend applications and associated frontend executable programs, such as browser plugins, executable cookies, applications executed locally on a user device, etc.

The program execution system 104 may also include a performance log 118 that stores records of the hardware performance of the program execution system 104, the network traffic of the program execution system 104, runtime errors of the programs 116, and/or other performance aspects of the program execution system 104.

The code base 106 may include or maybe the repository of source code for one or more of the programs 116. In some embodiments, the code base 106 may include multiple versions of source code from one or more programs 116, change logs for such versions, and/or other information generally stored with application source code. In some embodiments, the program execution system 104 may receive updates to programs 116 from the code base 106 when instructed by developers of the programs 116. Accordingly, in some embodiments, the code base 106 maybe regularly reviewed, amended, and supplemented by program developers.

It should be noted that the program execution system 104 is presented in FIG. 1 as a single computing system for ease of illustration and description. A person of skill in the art will appreciate that applications that are monitored for errors according to the present disclosure, and whose errors are addressed according to the present disclosure, can be executed by numerous computing systems in support of one or more services.

The domain error log 108 may be or may include repository of runtime errors in the programs 116 (e.g., programs executing within or otherwise supporting service of a common domain). Records of errors in the domain error log 108 may include, for example, error codes, when and where (e.g., the executing computing system, location in the code) each error occurred, one or more inputs to a program before an error occurred, and attempted resolutions to errors, including both successful and unsuccessful resolutions. An error record may also include, in some embodiments, performance data of the system in which the error occurred in the time period before the error and/or at the time of the error, such as input, processing load, network traffic, memory usage, and the like. Accordingly, the domain error log 108 may serve as a data source for previous system errors, indicative of both the causes of such errors and potential resolutions to such errors. In some embodiments, the domain error log 108 may store records of errors in frontend programs executing on end user devices.

The domain error log 108 may store records of errors in both software (the code of a program) and in the infrastructure executing the program. For example, for a software error, the domain error log 108 may store a thread in which the error occurred, a nature of the error (e.g., inability to invoke a call in the code, a failed dependency in the code, etc.), etc. For an infrastructure error, the domain error log 108 may include the portion of the infrastructure (e.g., a local device, a cloud service) in which the error occurred, and a nature of the error (e.g., cloud processing capacity reached).

The machine learning model 110 may be or may include one or more artificial intelligence tools or other machine learning model-based tools for detecting and/or correcting runtime errors in the programs 116. The machine learning model 110 may be, for example, a Generative Artificial Intelligence (AI) model such as a META LLAMA large language model (LLM), an OPENAI GPT LLM, GOOGLE GEMINI LLM, small language models, and/or non-generative AI models such as Natural Language Processing (NLP) or predictive AI models. The machine learning model 110, or a portion thereof, may be separate from, and communicate with, the error system 102, as shown in FIG. 1. In some embodiments, the machine learning model 110, or portion thereof, may be stored and/or executed by the error system 102. In some embodiments, the machine learning model 110 may be or may include a large language model, or another generative artificial intelligence model. Accordingly, and some embodiments, the machine learning model 110 may receive prompts in the form of text, images, sound files, and/or other model-intelligible input and may generate a response based on the prompt. For example, the machine learning model 110 may determine (e.g., detect or predict) one or more runtime errors and/or generate one or more remediation action recommendations to resolve one or more errors.

The error system 102 they include processor 120 and a non-transitory, computer-readable memory 122 storing instructions that, when executed by the processor 120, cause the error system 102 to perform one or more of the methods, operations, algorithms, etc. of this disclosure. The error system 102 may store a plurality of functional modules 124, 126, 128, 130, 132, 134, 136, which modules may be embodied as hardware and/or software. In some embodiments, the functional modules 124, 126, 128, 130, 132, 134, 136, may be embodied as instructions in the memory 122.

The model training module 124 may define one or more training data sets and train the machine learning model 110 using the training data. The training data may include, for example, records of errors in the domain error log 108 and code for the programs 112 in the codebase 106, in some embodiments. Accordingly, the model training module 124 may train the model 110 to determine runtime errors, including predicting before they occur based on performance data of the system running the programs (e.g., the program execution system 104), such as input, processing load, network traffic, memory usage, and the like, as well as recognizing errors that have occurred based on error log data.

The model training module 124 may further train the machine learning model 110 to generate remediation action recommendations for predicted or occurred errors. For example, the training data may include, in addition to error information, data regarding resolutions to those errors, whether such resolutions were successful or unsuccessful, the code related to such errors (e.g., code versions that resulted in errors and corrected code versions after those errors), and/or other resolution information.

The model training module 124 may conduct periodic re-training of the machine learning model 110. For example, the model training module 124 may update the training data set with additional predicted and actual errors that have occurred since the most recent training, and further train the machine learning model based on the updated training data. That is, the model training module 124 may receive implemented remediation actions and the outcomes of such remediation actions (e.g., successful or unsuccessful) and add such information to the training data. Re-training may occur every week, every month, etc. By continuously retraining on both current and past data, the machine learning model 110 can refine its understanding, minimize errors, and evolve alongside the changing demands of its environment. This iterative process not only enhances the model's adaptability but also provides a foundation for sustained improvements in accuracy and response generation quality.

The model training module 124 may alter the node weights and other aspects of the machine learning model through successive rounds of training in order to minimize a loss function respective of the performance of the machine learning model. As a result, training may include systematic analysis of historical error data by the machine learning model and training process to identify patterns and anomalies for error detection.

As part of generating training data sets, the model training module 124 may format error information so as to be useful to the machine learning model 110. For example, the model training module 124 may collate error log information related to a given error reported by a plurality of routines for input to the machine learning model as shown in Example 1 below:

[ERROR] [Time1] [MemoryMonitorThread] com.example.app.MemoryManager - High
memory usage detected:

- Current Memory Usage: 92%
- Maximum Heap Size: 100 MB
- GC Activity: Low
- Threshold Breach: 66%
- Potential Cause: Excessive object retention

[WARN] [Time2] [MemoryMonitorThread] com.example.app.CacheManager - Possible
memory leak in CacheManagerService:

- Total Cached Objects: 243,500
- Largest Object: sessionCache
- Retained Size: 1 GB
- Cache Eviction Policy: LRU (Least Recently Used)
- Warning: Cache eviction is not being triggered as expected

[ERROR] [Time3] [RequestHandlerThread-12] com.example.app.RequestHandler -
System performance degraded:

- Average Response Time: 100 ms (Expected: <5 ms)
- Active Threads: 45
- Blocked Threads: 15
- Pending Requests: 200
- User Sessions Impacted: 22

[DEBUG] [Time4] [GarbageCollectorMonitorThread] com.example.app.GCMonitor -
Garbage collection performance:

- GC Cycles: 2 (Last 5 minutes)
- Reclaimed Memory: 512 MB
- Unreachable Objects: 1,000+
- Suggestion: Manually trigger GC or investigate object retention issues

[INFO] [Time5] [RapidResolveAI] - Issue Resolved Automatically:

- Cleared 100,000 objects from sessionCache (CacheManagerService)
- Triggered GC (Recovered Memory: 3 GB)
- Temporary heap size increased to 5 GB
- Suggested Action: Review cache eviction policy for sessionCache
- Resolution Time: 1 minute

As shown in Example 1, a training data point for a given error may include a related series of error log entries related to error conditions or detected responsive activity, each with a type (e.g., error (“ERROR”), warning (“WARN”), debugging result (“DEBUG”), or resolution information (“INFO”)), a date and time (shown in example form as “Time1”, “Time2”, and so on), a thread the performed the logged activity (“MemoryMonitorThread”, “RequestHandlerThread”, and so on), an application in which the logged activity occurred (“com.example.app.MemoryManager”, “com.example.app.CacheManager”, and so on), the nature of the logged activity or detected condition (“High memory usage detected”, “Possible memory leak in CacheManagerService”, and so on), and further activity-specific or condition-specific details. The details may be generated by the relevant thread and appended to the error information for input to the machine learning model 110 by the model training module 124. Further, the model training module may determine related activity and condition entries in logs and collate those entries for definition as a single error data point for training input to the machine learning model 110.

In addition to error information, the example of Example 1 also includes error remediation information, such as the remediation action itself (the “INFO” activity) and the analysis that lead to that remediation action (the “DEBUG” activity). The logged analysis and/or activity may have been manual or may have been automatic, but its logging and compilation into training data enables automated analysis and actions by the system 100.

The error monitoring module 126 may monitor the program execution system 104 and predict the occurrence of errors, in some embodiments. For example, the error monitoring module 126 may monitor an application's metrics, such as input, processing load, network traffic, memory usage, and the like, and may log those metrics on a periodic basis (e.g., every minute, every hour, etc.). The error monitoring module 126 may compare current metrics to past metrics to identify anomalies indicative of a future runtime error. In some embodiments, the error monitoring module 126 may cause current metrics to be input to the machine learning model 110 to cause the machine learning model to predict future potential errors. The error monitoring module 110 may also take automated action in response to particular output of the application that is indicative of an error, such as a thrown exception, output error code, etc.

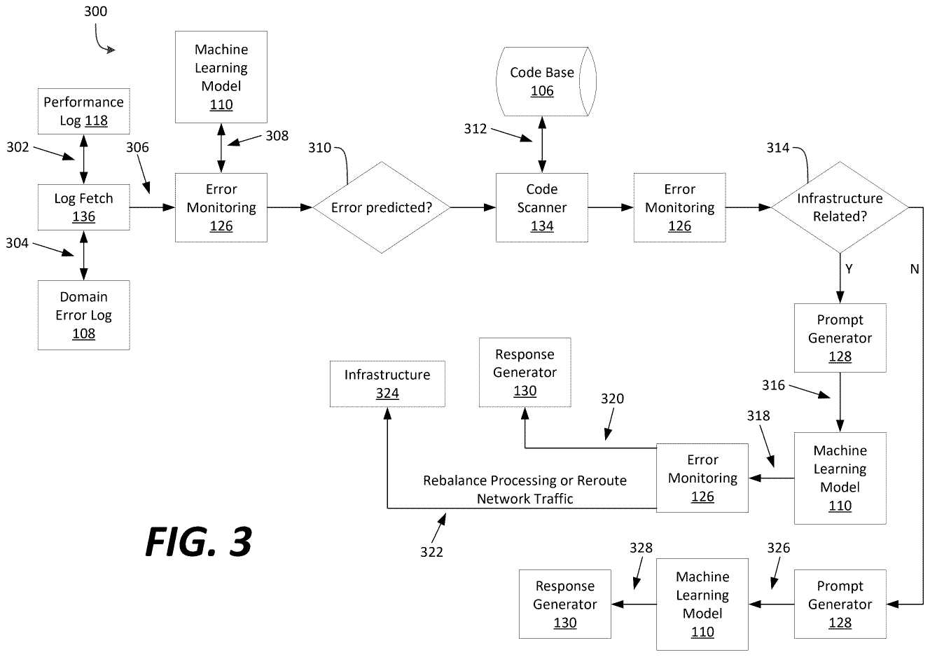

In some embodiments, the error monitoring module 126 may mediate the flow of data amongst the other aspects of the system 100. For example, the error monitoring module 126 may receive error information from end user devices or the program execution system 104 and cause that error information to be stored in the domain error log 108. The error monitoring module 126 may also mediate the flow of information between the machine learning model 110 and other modules, as will be described below in connection with FIGS. 2 and 3.

As part of generating remediation actions in response to actual or predicted errors, the error system 102 may apply the trained machine learning model. To do so, the error system 102 may both generate prompts for the machine learning model, generate responses (e.g., intended for developers) based on the output of the model in response to the prompts, and/or automatically cause remediation actions to be implemented.

The error system 102 may include a prompt generation module 128 that formats information for analysis by the machine learning model 110 in the form of a prompt that is processable by the machine learning model 110 and that indicates the desired analysis by the machine learning model 110. A prompt may instruct the machine learning model to recommend an immediate remediation action to fix the error, and/or instruct the machine learning model to recommend proactive measures to prevent the error from occurring again.

In some embodiments, the prompt generation module 128 may instruct the machine learning model 110 to simulate one or more remediation actions, such as rebalancing of processing resources, redirection of network traffic, revisions to code, etc., before recommending such remediation actions.

The error system 102 may include a response generation module 130 that receives the output of the machine learning model 110 and formats that output as a user-readable response to a user (e.g., a developer user). For example, the response generation module may receive one or more recommended error remediation actions from the machine learning model 110, which remediation actions may include a recommended code change. The response generation module may retrieve and copy the existing code from the code base 106 (e.g., via the code scanner module, as described below), determine the differences between the existing code and the recommended code, and generate a display of those differences. Further, the response generation module may add to the response the location of the recommended code change in the code base, as well as functional information about the relevant code (e.g., version information, input information, etc.). The response generator module 130 may therefore generate a compilation of one or more remediation actions and supporting information for the user's consumption. The response may be structured to deliver practical solutions (e.g., code snippets, tips, prevention strategies) to the developer. Precise, unambiguous remediation steps can reduce resolution time.

The response generation module 130 may, in some embodiments, report hardware-based remediation actions to a developer user, including remediation actions that are caused to be implemented automatically by the error system 102 as well as remediation actions that require user action to implement.

An example response that may be generated, formatted, and output by the response generation module 130 is provided below as Example 2:

A classic NullPointerException (NPE) error!
**Cause:**
The error occurs because you're trying to invoke a method (‘size( )‘) on a
‘List‘ object (‘l‘) that is currently ‘null‘.
This means that you've either not initialized the list or it's been set to
‘null‘ somewhere in your code.
**Resolution:**
The error message is quite clear: ‘Cannot invoke \″java.util.List.size( )\″
because \″l\″ is null‘.
This means that the variable ‘l‘ is null, and you're trying to call a method
on it (‘size( )‘) that requires it not be null.
**Check your code**:
Review the code around line 12 of your ‘Main.java‘ file and ensure that
you're properly initializing the ‘List‘ object before using its methods.
To resolve this issue, you need to ensure that ‘l‘ is initialized before
calling any methods on it.
Here are some possible solutions:
1. **Check if ‘l‘ is null before calling ‘size( )‘**: Add a simple null check
before calling ‘size( )‘:
‘‘‘java
if (l != null) {
int size = l.size( );
// do something with the size
} else {
System.out.println(\″List ′l′ is null\″);
}
‘‘‘
Wrap any method calls on the list with null checks to prevent this exception
from occurring in the first place.
2. **Initialize ‘l‘ before using it**: If you're sure that ‘l‘ should never
be null, make sure you initialize it properly:
‘‘‘java
List<String> l = new ArrayList<>( );
// ... add elements to the list ...
‘‘‘
**Long-term tips to prevent NPEs:**
1. **Use proper initialization and validation**: Ensure that all variables
are initialized before using them.
2. **Check for null values**: Regularly check for null values when calling
methods or accessing properties.
3. **Use ‘Optional‘ classes (Java 8+)**: Consider using Java's ‘Optional‘
class to handle null values in a more robust way.
4. **Test your code thoroughly**: Write unit tests and integration tests to
catch NPEs early on.
**Simulated fix applicable in this scenario:**
Assuming you're using the ‘List‘ interface and want to iterate over its
elements, here's an example of how you can safely handle the null check:
‘‘‘java
List<String> l = ...; // assume ′l′ is initialized elsewhere
if (l != null) {
for (String s : l) {
System.out.println(s);
}
} else {
System.out.println(\″List ′l′ is null\″);
}
‘‘‘
If you're using Java 8 or later, you can use the ‘Stream‘ API to make it more
concise:
‘‘‘
java
List<String> l = ...; // assume ′l′ is initialized elsewhere
if (l != null) {
l.stream( )
.forEach(System.out::println);
} else {
System.out.println(\″List ′l′ is null\″);
}
‘‘‘
Remember, the key to preventing NPEs is to ensure proper initialization and
validation of your variables.

As shown in Example 2, the response generation module 130 may format the error and recommended resolution information in the form of an explanation of the error, the cause of the error, and a recommended remediation action, including recommended changes to the code to fix the particular error and high-level tips for better coding practices to avoid similar errors. Each of these aspects may have been learning by the machine learning model 110 based on its training and generated by the machine learning model 110 in response to a particular error prompt generated by the prompt generation module 128.

The error system 102 may include a user input/output module 132 configured to support a developer user interface that receives developer user input through a user interface and generates output to the developer user through the interface. For example, the user I/O module 132 may interface with a SLACK interface or similar interface. The user I/O module 132 may monitor the user interface and retrieve user input text from the interface in response to predetermined input, such as a hashtag, keyword, or codeword, via which the user can invoke error identification and resolution functionality. The user I/O module may also output error remediation actions, discussed herein, to the user in response to the user's invocation of the of the error identification and resolution functionality, and/or automatically when the error system 102 detects or predicts an error.

The error system 102 may include a code scanner module 134 that may receive an indication of an error and may scan the code base 106 to find the lines of code where the error occurred. The code scanner module 134 may receive error information from the error monitoring module 126, for example, and determine and retrieve relevant lines of code in response to the error information.

The error system 102 may include a log fetch module 136 that retrieves information from the domain error log 108 and/or the performance log 118 in order to assist the model training module 124 in building a training data set, to collect system information and error information to input to the machine learning model 110 for determination of errors and remediation actions, in order to present prior error information to a user (e.g., developer), and/or for other purposes.

The log fetch module 136 may be configured to formulate one or more search queries for searching the domain error log 108 and/or the performance log 118 to retrieve information related to reported, predicted, or other extant errors. For example, the log fetch module 136 may search for and retrieve data regarding performance and errors within a specific time frame (e.g., performance data for a time period before a known error, error log information within a time before and after when a user believes an error occurred, etc.), data for specific error types (e.g., matching a reported or known error code), data for specific applications, data for specific computing systems, and the like.

As will be described in further detail below with respect to FIGS. 2-4, the error monitoring and resolution system 102 may, in conjunction with the domain error log 108, machine learning model 110, and/or code base 106, monitor the execution of one or more programs on the program execution system 104 (e.g., multiple such systems) for actual or predicted runtime errors. The error monitoring and resolution system 102 may also receive indications of errors from developer users directly, such as when an error occurs or when a developer hypothesizes an error (e.g., based on an error in a similar program) and seeks a preemptive fix. When an error is identified, the error monitoring and resolution system 102 may determine a cause of the error and/or one or more remediation actions in response to the error, such as hardware or software-based solutions to the error and/or hardware or software-based preemptive actions to prevent the error from recurring or to prevent a predicted error.

FIG. 2 is a flow chart and block diagram illustrating an example method 200 of addressing a detected error. As shown, aspects of the method 200 may be performed by the system 100. Accordingly, one or more portions of the method 200 may be computer-implemented.

The method 200 may include, at operation 204, receiving an indication of an error from a user device 202. The user may enter the error indication through a dedicated user interface or interface portion. In some embodiments, the developer user may enter an indication of an error into a SLACK or similar interface. For example, a user may enter a hashtag, keyword, codeword, etc. through the interface and, in response, the user I/O module 132 may present, a menu in which the user can enter error details, such as an application name, a type of error or alert (500, 400, 403, alerts, etc.), the time frame in which the error occurred, and/or other error details.

The user I/O module 132 may, in response to receiving the error details, authenticate the source of the request (e.g., whether the request comes from a valid user). For example, the I/O module 132 may compare the user identity to a list of users entitled to receive information respective of the application for which the user reported the error.

At operation 206, the user I/O module may pass the reported error details to the log fetch module 136 which may, in response, retrieve relevant data from the performance log 118 and the domain error log 108 at operations 208, 210. The data fetch may be based on the error details provided by the user. That is, the log fetch module 136 may search the logs 108, 118 for the complete details of the one or more errors reported by the user. For example, the log fetch module may search the logs 108, 118 for and retrieve data logged within a threshold amount of time before and after the time reported by the user, data related to errors having the error code reported by the user, data related to the system executing the program for which the user reported the error, and so on.

At operation 212, the log fetch module 136 may send the fetched log data and the error information to the error monitoring module 126, which may determine a cause of the error by parsing the error information and log information to obtain information such as the type of error, the class, the routine and the line where the error occurred.

At operation 214, the error monitoring module may pass the parsed error information to the code scanner module 134 which may, in response, scan the code in the code base 106 and retrieve the code where the error occurred from the code base 106. The code retrieved may include the code where the error occurred and surrounding code, such as all code within the function in which the error occurred. The code scanner module 134 may scan the code base on based on a program, file, line, etc. identified in the log data.

At operation 216, the code scanner 134 may pass the retrieved code and the parsed error information to the user I/O module 132 which may, in response, convert the information to a generic format, which may include removing sensitive code (e.g., class-sensitive data) and sensitive information. For example, the I/O module 132 may remove information such as internal URLs, internal file paths, custom error messages, and other information specific to the internal operations of the domain. The I/O module 132 may format the error information and retrieved code in a user-friendly format, highlighting the error information, and display the error information to the user along with a query to the user as to whether the user wants error resolution (e.g., remediation) recommendations at block 218.

As past of generating generic error information, the I/O module 132 use regex patterns to match source code details in an error message (e.g., class names, file paths, line numbers). Once matched, the details may be replaced with more generic labels. For example, for an error message of “ERROR at com.example.app.ClassName.method(ClassName.java:12)”, the I/O module 132 may use regular expressions to match the pattern of the error message and remove the path of the class while keeping the required information intact. The I/O module 132 may break down the error message or stack trace into smaller pieces, analyze each part individually, and remove or modify the parts designated as sensitive. For example, the I/O module 132 may refer to a preexisting list of aspects of an error message that are sensitive, and replace those aspects with generic information by referring to a replacement lookup table, for example.

When the user confirms (e.g., responds in the affirmative) that a recommendation remediation is desired, the user I/O module 132 may, at operation 220, pass the generic-format error information to the prompt generator 128.

The prompt generator 128 may generate a prompt to the machine learning model 110 that includes error information (in its generic form) and an instruction for the machine learning model 110 to generate one or more recommended remediation actions for the error and, at operation 222, input the prompt to the machine learning model 110.

The machine learning model 110 may generate, in response to the prompt from the prompt generator module 128, one or more recommended error remediation actions. Because the machine learning model 110 is trained on previous errors involving the system and applications being reported for errors, or similar systems and programs, the machine learning model's consideration and analysis of the input data is functionally similar to a simulation of potential solutions and determination of the likely effectiveness of those potential solutions. In some embodiments, the machine learning model 110 may actually simulate one or more remediation actions, such as a source code revision (by simulating the output of the code given the input that caused the error, for example), an infrastructure revision (by simulating execution of the program code given additional memory or processor resources, for example), etc. The one or more recommendations may be output to the response generator 130 at operation 224. The one or more remediation actions may include, for example, altering a processing unit capacity assigned to a task of the program, halting a process respective of the program, rerouting network traffic related to the program, altering code of the program, or another remediation action.

The response generator 130 may receive the error information from the user I/O module at operation 226 and the one or more recommended remediation actions from the machine learning model at operation 224 and, in response, generate a user-friendly output detailing the error, the one or more recommended remediation actions, and best practices recommended by the machine learning model. At operation 226, the response generator module 130 may cause the output to be displayed to the user or otherwise output via the user I/O module 132.

FIG. 3 is a flow chart and block diagram illustrating an example method 300 of determining runtime errors and generating remediation action recommendations in response to those errors. The method 300 is shown in conjunction with aspects of the system 100. Accordingly, one or more portions of the method 300 may be computer-implemented.

The method 300 may include, at operations 302, 304, the log fetch module 136 retrieving data from the performance log 118 and the domain error log 108, and passing that data to the error monitoring module at operation 306. The log fetch module 136 may perform operations 302, 304 on a periodic basis, such as an hourly basis, in some embodiments, to continuously monitor for potential runtime errors and to initiate the remaining aspects of the method 300.

The data retrieved by the log fetch module 136 at operations 302, 304 may be determined based on the scope of monitoring to be performed. The log fetch module 136 may retrieve data respective of a particular application (e.g., error log information identifying that application, or performance data particular to that application, such as network activity over a communications socket utilized by the particular application), or may retrieve data respective a plurality of applications. Similarly, the log fetch module 136 may retrieve data respective of a single computing system, or of multiple computing systems.

At operation 308, the error monitoring module 126 may input the log information to the machine learning model 110 with a prompt to analyze the log information for indications of an actual and/or predicted error. The machine learning model 110 may have been trained on previous performance information and error log information to determine errors. The machine learning model 110 may output, in some embodiments, that no error is detected. In other embodiments, the machine learning model 110 may output that an error has occurred or is predicted, along with details of the error, such as an error code, application in which the code has occurred, and/or other details.

At operation 310, the error monitoring module 126 may determine if an error is detected based on the output of the machine learning model 110. Receiving the output of the machine learning model at operation 310, where that output includes an indication of an error, may be an example of receiving an indication of a runtime error. If an error is determined at block 310, the error monitoring module 126 may pass the determined error information to the code scanner 134, which may determine the line and the class where the error occurred or is predicted to occur, by scanning the code base 106 at operation 312 based on the error information (e.g., information from the error log, performance log, and the machine learning model 110 output).

At operation 314, the relevant code may be returned to the error monitoring module 126, which may determine based on the error logs and code scan if the error is infrastructure-related. Operation 314 may include, for example, determining if performance log data indicates a backlog of network activity, or where an error log indicates a hardware-specific error. Such errors may include, an “out of memory” error or the like.

If, at operation 314, the error monitoring module 126 determines that the error is infrastructure-related, the error monitoring module 126 may pass the error information to the prompt generator module 128.

In response to the determination that the error is infrastructure-related, the prompt generator module 128 may generate a prompt to the machine learning model 110 that includes error information and an instruction for the machine learning model to generate one or more infrastructure-related recommended remediation actions for the error. In some embodiments, the prompt may include an instruction to simulate one or more potential remediation actions. The error information may include, for example, an error code, application in which the error is determined, the relevant code copied from the code base, performance aspects of the system executing the application and related to the error, etc. For example, the machine learning model may recommend that network traffic be rebalanced, that processing of a task be distributed to a different set of resources (e.g., by assigning another server to the task), and the like. At operation 316, the prompt generator module 128 may input the generated prompt to the machine learning model 110.

The one or more remediation action recommendations from the machine learning model 110 may be input to the error monitoring module 126 at operation 318, which may pass the recommendations to the response generator 130 at operation 320. The response generator 130 may format the recommendations for user consumption and output the recommendations to a user interface, as described with respect to the method 200 of FIG. 2.

The error monitoring module 126 may also, at operation 322, communicate with the relevant infrastructure 324 to automatically cause one or more remediation actions recommended by the machine learning model 110 to be implemented. For example, the error monitoring module 126 may instruct a computing system executing a monitored application to redirect its network traffic, or to rebalance its processor or memory resources. The instructed computing system may be or may include, for example, a cloud computing service, and the error monitoring module 126 may generate a processing balance request and transmit the request to the cloud computing service, thereby also automatically causing the recommended remediation action to be implemented. Additionally or alternatively, the instructed computing system may be one or more servers under the control of the system performing the method 300, and the error monitoring module 126 may cause implementation via direct instruction.

If the error monitoring module 126 determines that the error is not infrastructure-related then the prompt generator may generate a prompt for the machine learning model 110 that includes the error information and an instruction to generate one or more software-based recommended remediation actions to resolve and/or prevent the error. The error information may be genericized, as described above. At operation 326, the prompt generator may input the prompt to the machine learning model 110. The machine learning model 110 may use the prompt containing the generic error details, to simulate the best possible resolution, and to suggest best practices to prevent the issue from recurring.

The prompt for a software-related error generated by the prompt generator 128 may include different error details and different instructions than a prompt for an infrastructure-related error. For example, the location in code where the error occurred may be included in a software error-related prompt, but not an infrastructure error-related prompt. In another example, processor usage of the executing system may be included in a prompt for an infrastructure-related error, but not a software-based error.

At operation 328, the response generator may receive the output of the machine learning model and convert the output, including one or more recommended remediation actions, to a user-friendly format and output that and cause that output to be displayed via the user interface for developers.

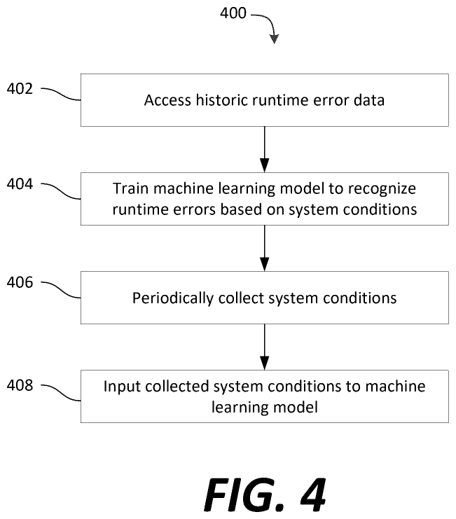

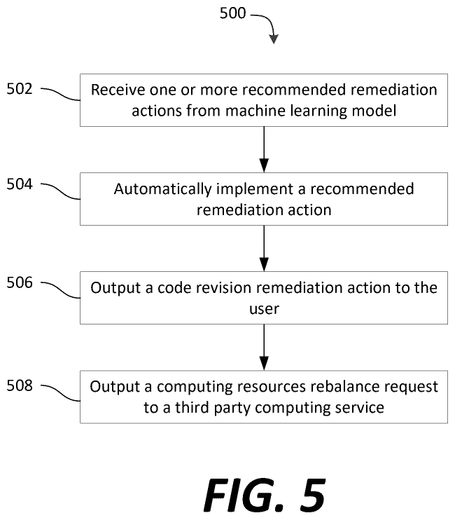

FIGS. 4 and 5 will be described below to provide additional details on the monitoring and remediation aspects of FIGS. 1-3 above. In some embodiments, the methods 400, 500 of FIGS. 4 and 5 may be performed in conjunction, with aspects of FIG. 4 applied to determine runtime errors and aspects of FIG. 5 applied for remediation of determined runtime errors. In other embodiments, one method 400 or 500 may be performed without the other.

FIG. 4 is a flow chart illustrating an example method 400 of automated error monitoring. The method 400, or one or more portions of the method 400, may be performed by the error system 102 of FIG. 1, and thus the method 400 may be computer-implemented.

The method 400 may include, at operation 402, accessing historic runtime error data respective of one or more application programs. Operation 402 may include, for example, retrieving data respective of a plurality of runtime errors in the application programs. Such data may include, for example, error codes, when and where each error occurred, one or more inputs to a program before an error occurred, network traffic respective of the machine executing the application, processor and memory usage of the machine executing the application, code at which each error occurred, and attempted resolutions to errors, including both successful and unsuccessful resolutions. The data accessed at operation 402 may be respective of application programs that were executed on a particular machine, or may be respective of applications programs executed by a plurality of machines. The data accessed at operation 402 may be respective of a given domain within which an application program to be monitored executes.

The method 400 may further include, at operation 404, training a machine learning model to recognize runtime errors in application programs based on system conditions of the computing systems executing those application programs. For example, operation 404 may include defining one or more training data sets, where a training data set includes a plurality of errors and information associated with those errors. A given training data set may be respective of a single application program or of a plurality of application programs. A given training data set may be respective of a particular code version of an application program, or of a plurality of code versions.

Training at operation 404 may include training the machine learning model to recognize existing errors based on error logs and/or to predict potential errors based on error logs (e.g., where errors may cascade) and/or system conditions. Accordingly, operation 404 may include training the model to recognize runtime errors before they occur (i.e., to predict runtime errors) based on performance data of the system running the programs, such as input, processing load, network traffic, memory usage, and the like.

Training at operation 404 may further include training the machine learning model to generate recommended remediation actions for predicted or occurred errors, in some embodiments.

The method 400 may further include, at operation 406, periodically collecting system conditions, e.g., conditions of one or more computing systems executing one or more application programs to be monitored for runtime errors. The system condition information may be similar to the information accessed at operation 402, but substantially real-time or recent versions of such data. For example, operation 406 may include collecting processor and memory usage, network traffic, error log information, and the like. Operation 406 may be performed every minute, every hour, twice per day, once per day, or at another appropriate frequency or interval.

The method 400 may further include, at operation 408, inputting the collected system conditions to the trained machine learning model in order to detect and/or predict runtime errors in the one or more application programs to be monitored for runtime errors. Operation 408 may be performed periodically in conjunction with operation 406. Operation 408 may include inputting the collected system information along with an instruction for the machine learning model to detect and/or predict runtime errors in one or more applications, and/or to generate one or more recommended remediation actions to any such errors. Operation 408 may include removing any sensitive or confidential information from the system information.

Operation 408 may include, in some embodiments, scanning a codebase of the program for which an error was determined to determine, based on the detected runtime error, a code location in the codebase related to the error. For example, the error determination may be based on an entry in an error log, which entry may include a file and line of the faulty code. In another example, where the error determination is based on a prediction by the machine learning model, the code scan may be based on a location in the code where similar errors occurred in the past (e.g., the machine learning model may output a predicted portion of the code base where the error is predicted).

Operation 408 may further include, in some embodiments, automatically generating, based on the error information and based on the determined code location, a prompt for the machine learning model and inputting the generated prompt to the machine learning model. For example, the prompt may include, as noted above, information about the determined error and an instruction for the machine learning model to generate one or more recommended remediation actions for the error.

FIG. 5 is a flow chart illustrating an example method 500 of remediation of detected or predicted runtime errors in application programs. The method 500, or one or more portions of the method 500, may be performed by the error system 102 of FIG. 1, and thus the method 500 may be computer-implemented.

The method 500 may include, at operation 502, receiving one or more recommended remediation actions regarding a runtime error in an application program from a machine learning model, such as a model trained to provide such recommendations given a state of a computing system executing the application program. The recommended remediation action(s) may include one or more of a reallocation or other change to a resource, such as memory usage, processor usage, network traffic, or other infrastructure-based action, and/or a software-based action, such as a change to the source code of an application program, or terminating a process of the program.

The method 500 may further include, at operation 504, automatically implementing one or more of the recommended remediation actions. Operation 504 may include, for example, altering the memory usage, processor usage, network traffic, or other hardware setting of a computing system executing the application program for which an error was determined, where the computing system is under the command or control of the system performing the method 500.

The method 500 may further include, at operation 506, outputting a code revision remediation action to a user, such as a developer user. Operation 506 may include, for example, adding contextual code from a codebase respective of the erroneous application and displaying the recommended code revision and contextual code to a developer user. The display may be in response to the user's request for a remediation to an error, in some embodiments. The method 500 may further include, at operation 508, outputting a computing resources rebalance request to a third party computing service, such as a cloud computing service executing the erroneous application program. Operation 508 may include, for example, generating an instruction in an IAC (Infrastructure As Code) format. The instruction may identify, in some embodiments, a resource (e.g., a computing resource) and a desired status of that resource, such that the third party computing service changes, in response, the status of the identified resource to the desired status included in the instruction.

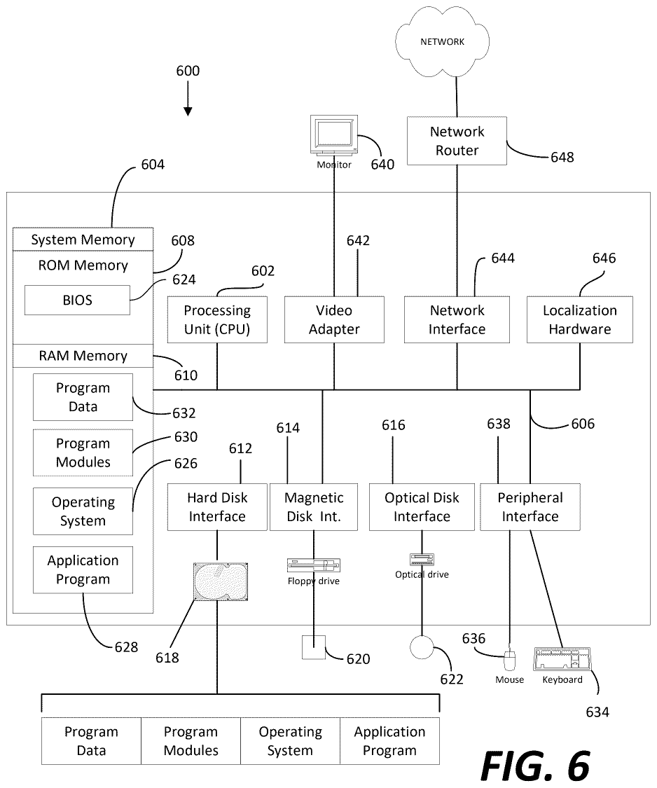

FIG. 6 is a block diagram of an example computing system 600, such as a desktop computer, laptop, smartphone, tablet, or any other such device having the ability to execute instructions, such as those stored within a non-transient, computer-readable medium. Furthermore, while described and illustrated in the context of a single computing system 600, those skilled in the art will also appreciate that the various tasks described hereinafter may be practiced in a distributed environment having multiple computing systems 600 linked via a local or wide-area network in which the executable instructions may be associated with and/or executed by one or more of multiple computing systems 600.

In its most basic configuration, computing system environment 600 typically includes at least one processing unit 602 and at least one memory 604, which may be linked via a bus 606. Depending on the exact configuration and type of computing system environment, memory 604 may be volatile (such as RAM 610), non-volatile (such as ROM 608, flash memory, etc.) or some combination of the two. Computing system environment 600 may have additional features and/or functionality. For example, computing system environment 600 may also include additional storage (removable and/or non-removable) including, but not limited to, magnetic or optical disks, tape drives and/or flash drives. Such additional memory devices may be made accessible to the computing system environment 600 by means of, for example, a hard disk drive interface 612, a magnetic disk drive interface 614, and/or an optical disk drive interface 616. As will be understood, these devices, which would be linked to the system bus 606, respectively, allow for reading from and writing to a hard disk 618, reading from or writing to a removable magnetic disk 620, and/or for reading from or writing to a removable optical disk 622, such as a CD/DVD ROM or other optical media. The drive interfaces and their associated computer-readable media allow for the nonvolatile storage of computer readable instructions, data structures, program modules and other data for the computing system environment 600. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 600.

A number of program modules may be stored in one or more of the memory/media devices. For example, a basic input/output system (BIOS) 624, containing the basic routines that help to transfer information between elements within the computing system environment 600, such as during start-up, may be stored in ROM 608. Similarly, RAM 610, hard drive 618, and/or peripheral memory devices may be used to store computer executable instructions comprising an operating system 626, one or more applications programs 628, other program modules 630, and/or program data 632. Still further, computer-executable instructions may be downloaded to the computing environment 600 as needed, for example, via a network connection. The applications programs 628 may include, for example, the application programs 116.

An end-user may enter commands and information into the computing system environment 600 through input devices such as a keyboard 634 and/or a pointing device 636. While not illustrated, other input devices may include a microphone, a joystick, a game pad, a scanner, etc. These and other input devices would typically be connected to the processing unit 602 by means of a peripheral interface 638 which, in turn, would be coupled to bus 606. Input devices may be directly or indirectly connected to processor 602 via interfaces such as, for example, a parallel port, game port, firewire, or a universal serial bus (USB). To view information from the computing system environment 600, a monitor 640 or other type of display device may also be connected to bus 606 via an interface, such as via video adapter 642. In addition to the monitor 640, the computing system environment 600 may also include other peripheral output devices, not shown, such as speakers and printers.

The computing system environment 600 may also utilize logical connections to one or more computing system environments. Communications between the computing system environment 600 and the remote computing system environment may be exchanged via a further processing device, such a network router 648, that is responsible for network routing. Communications with the network router 648 may be performed via a network interface component 644. Thus, within such a networked environment, e.g., the Internet, World Wide Web, LAN, or other like type of wired or wireless network, it will be appreciated that program modules depicted relative to the computing system environment 600, or portions thereof, may be stored in the memory storage device(s) of the computing system environment 600.

The computing system environment 600 may also include localization hardware 646 for determining a location of the computing system environment 600. In embodiments, the localization hardware 646 may include, for example only, a GPS antenna, an RFID chip or reader, a WiFi antenna, or other computing hardware that may be used to capture or transmit signals that may be used to determine the location of the computing system environment 600. Data from the localization hardware 646 may be included in a callback request or other user computing device metadata in the methods of this disclosure.

The computing system 600, or one or more portions thereof, may embody a program execution system 104, error system 102, and/or another system, in some embodiments.

In a first aspect of the present disclosure, a computer-implemented method is provided that includes receiving, by a computing system, an indication of a runtime error respective of a computer program, scanning, by the computing system, a codebase of the program to determine, based on the runtime error indication, a code location in the codebase related to the error, automatically generating, by the computing system, based on the indication and the determined code location, a prompt for a machine learning model, inputting, by the computing system, the generated prompt to the machine learning model to cause the machine learning model to generate one or more recommended remediation actions, receiving, by the computing system from the machine learning model, one or more remediation actions in response to the generated prompt, and causing, by the computing system, at least one of the one or more remediation actions to be implemented in response to the indication of the runtime error.

In an embodiment of the first aspect, causing at least one of the one or more remediation actions to be implemented includes one or more of generating, by the computing system, a user-readable compilation of the one or more remediation actions and causing the compilation to be output to a user interface, generating, by the computing system, a prompt to a third party network service to reallocate computing resources for the program, and causing the generated prompt to be transmitted to the third party network service, or automatically executing, by the computing system, the one of the one or more remediation actions.

In an embodiment of the first aspect, the one or more remediation actions include one or more of reallocation of computing resources to one or more tasks of the program, redirecting network traffic related to the program, terminating a process of the program, or revising source code for the program.

In an embodiment of the first aspect, the program executes within a domain, and the method further includes accessing, by the computing system, a repository of historical runtime error data points respective of the domain, each data point including an error and one or more of a successful resolution or an unsuccessful resolution, and training the machine learning model based on the historical runtime error data points.

In an embodiment of the first aspect, the method further includes receiving, by the computing system, an outcome of the implemented at least one remediation action, and training the machine learning model based on the at least one remediation action and the outcome.

In an embodiment of the first aspect, the method further includes periodically inputting, by the computing system, performance data respective of the program into the machine learning model to cause the machine learning model to analyze the performance data for runtime errors, and receiving, from the machine learning model by the computing system, in response to the input of performance data, the indication of a runtime error respective of the computer program. In a further embodiment of the first aspect, the method further includes generating, by the computing system, a user-readable description of the runtime error indicated by the machine learning model, causing, by the computing system, the description to be output to a user interface, and receiving, from a user via the computer interface, a request to provide recommended remediation actions for the runtime error, wherein automatically generating the prompt for the machine learning model is in response to receiving the user request.

In a second aspect of the present disclosure, a computer-implemented method is provided that includes accessing a repository of historical runtime error data points respective of a domain, each data point including a runtime error and one or more of a successful resolution or an unsuccessful resolution, training a machine learning model, based on the historical runtime error data points, to provide recommended remediation actions as output in response to runtime errors as input, receiving, by a computing system, an indication of a runtime error respective of a computer program executing within the domain, automatically generating, by the computing system, based on the indication, a prompt for a machine learning model, inputting, by the computing system, the generated prompt to the machine learning model to cause the machine learning model to generate one or more recommended remediation actions, and causing, by the computing system, at least one of the one or more remediation actions to be implemented in response to the indication of the runtime error.

In an embodiment of the second aspect, the method further includes receiving, by the computing system, an outcome of the implemented at least one remediation action, and training the machine learning model based on the at least one remediation action and the outcome.

In an embodiment of the second aspect, the method further includes automatically executing, by the computing system, the one of the one or more remediation actions, wherein the one of the one or more remediation actions include altering a processing unit capacity assigned to a task of the program, halting a process respective of the program, or rerouting network traffic related to the program.

In an embodiment of the second aspect, the machine learning model is a large language model.

In an embodiment of the second aspect, each data point further includes performance data respective of a computing system executing a program that experienced the runtime error, and training the machine learning model further includes training the machine learning model to predict runtime errors as output given performance data of a computing system as input. In a further embodiment of the second aspect, the method further includes periodically inputting, by the computing system, performance data respective of the program into the machine learning model to cause the machine learning model to analyze the performance data for runtime errors, and receiving, from the machine learning model by the computing system, in response to the input of performance data, the indication of a runtime error respective of the computer program.

In a third aspect of the present disclosure, a computer-implemented method is provided that includes inputting, by a computing system, performance data respective of a program into a machine learning model to cause the machine learning model to analyze the performance data for runtime errors, receiving, from the machine learning model by the computing system, in response to the input of performance data, an indication of a runtime error respective of the computer program, scanning, by the computing system, a codebase of the program to determine, based on the runtime error indication, a code location in the codebase related to the error, inputting, by the computing system, the code location to the machine learning model to cause the machine learning model to generate one or more recommended remediation actions for the indicated runtime error, receiving, by the computing system from the machine learning model, one or more remediation actions, and causing, by the computing system, at least one of the one or more remediation actions to be implemented in response to the indication of the runtime error.

In an embodiment of the third aspect, the performance data includes, with respect to a computing system executing the program, one or more of processor usage of the program, memory usage of the program, or network traffic related to the program.

In an embodiment of the third aspect, inputting the code location includes copying code located at the code location and inputting the copied code. In a further embodiment of the third aspect, the received one or more remediation actions include a recommended revision to the copied code.

In an embodiment of the third aspect, the inputting is automatically performed periodically for each of a plurality of programs.

In an embodiment of the third aspect, the method further includes, in response to receiving the indication of a runtime error, generating, by the computing system, a user-readable notification and causing the notification to be output to a user in a user interface, and receiving, from the user, via the user interface, a confirmation that remediation of the runtime error is desired, wherein causing at least one of the one or more remediation actions to be implemented is further in response to the user confirmation.

In an embodiment of the third aspect, the method further includes, in response to receiving the indication of a runtime error, determining that the error is or is not related to hardware infrastructure, when the error is determined to be related to hardware infrastructure, generating an infrastructure-related prompt for the machine learning model to cause the machine learning model to generate one or more hardware infrastructure-related recommended remediation actions, and when the error is determined not to be related to hardware infrastructure, retrieving data from one or more logs of the performance data and generating a prompt for the machine learning model based on the retrieved log data to cause the machine learning model to generate one or more code-related recommended remediation actions.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A computer-implemented method comprising:
receiving, by a computing system, an indication of a runtime error respective of a computer program;
scanning, by the computing system, a codebase of the program to determine, based on the runtime error indication, a code location in the codebase related to the error;
automatically generating, by the computing system, based on the indication and the determined code location, a prompt for a machine learning model;
inputting, by the computing system, the generated prompt to the machine learning model to cause the machine learning model to generate one or more recommended remediation actions;
receiving, by the computing system from the machine learning model, one or more remediation actions in response to the generated prompt; and
causing, by the computing system, at least one of the one or more remediation actions to be implemented in response to the indication of the runtime error.

2. The computer-implemented method of claim 1, wherein causing at least one of the one or more remediation actions to be implemented comprises one or more of:
generating, by the computing system, a user-readable compilation of the one or more remediation actions and causing the compilation to be output to a user interface;
generating, by the computing system, a prompt to a third party network service to reallocate computing resources for the program, and causing the generated prompt to be transmitted to the third party network service; or
automatically executing, by the computing system, the one of the one or more remediation actions.

3. The computer-implemented method of claim 1, wherein the one or more remediation actions comprise one or more of:
reallocation of computing resources to one or more tasks of the program;
redirecting network traffic related to the program;
terminating a process of the program; or
revising source code for the program.

4. The computer-implemented method of claim 1, wherein the program executes within a domain, the method further comprising:
accessing, by the computing system, a repository of historical runtime error data points respective of the domain, each data point comprising an error and one or more of a successful resolution or an unsuccessful resolution; and
training the machine learning model based on the historical runtime error data points.

5. The computer-implemented method of claim 1, further comprising:
receiving, by the computing system, an outcome of the implemented at least one remediation action; and
training the machine learning model based on the at least one remediation action and the outcome.

6. The computer-implemented method of claim 1, further comprising:
periodically inputting, by the computing system, performance data respective of the program into the machine learning model to cause the machine learning model to analyze the performance data for runtime errors;
receiving, from the machine learning model by the computing system, in response to the input of performance data, the indication of a runtime error respective of the computer program.

7. The computer-implemented method of claim 6, further comprising:
generating, by the computing system, a user-readable description of the runtime error indicated by the machine learning model;
causing, by the computing system, the description to be output to a user interface; and
receiving, from a user via the computer interface, a request to provide recommended remediation actions for the runtime error;
wherein automatically generating the prompt for the machine learning model is in response to receiving the user request.

8. A computer-implemented method comprising:
accessing a repository of historical runtime error data points respective of a domain, each data point comprising a runtime error and one or more of a successful resolution or an unsuccessful resolution;
training a machine learning model, based on the historical runtime error data points, to provide recommended remediation actions as output in response to runtime errors as input;
receiving, by a computing system, an indication of a runtime error respective of a computer program executing within the domain;
automatically generating, by the computing system, based on the indication, a prompt for a machine learning model;
inputting, by the computing system, the generated prompt to the machine learning model to cause the machine learning model to generate one or more recommended remediation actions; and
causing, by the computing system, at least one of the one or more remediation actions to be implemented in response to the indication of the runtime error.

9. The computer-implemented method of claim 8, further comprising:
receiving, by the computing system, an outcome of the implemented at least one remediation action; and
training the machine learning model based on the at least one remediation action and the outcome.

10. The computer-implemented method of claim 8, further comprising:
automatically executing, by the computing system, the one of the one or more remediation actions, wherein the one of the one or more remediation actions comprises altering a processing unit capacity assigned to a task of the program, halting a process respective of the program, or rerouting network traffic related to the program.

11. The computer-implemented method of claim 8, wherein the machine learning model is a large language model.

12. The computer-implemented method of claim 8, wherein:
each data point further comprises performance data respective of a computing system executing a program that experienced the runtime error; and
training the machine learning model further comprises training the machine learning model to predict runtime errors as output given performance data of a computing system as input.

13. The computer-implemented method of claim 12, further comprising:
periodically inputting, by the computing system, performance data respective of the program into the machine learning model to cause the machine learning model to analyze the performance data for runtime errors;
receiving, from the machine learning model by the computing system, in response to the input of performance data, the indication of a runtime error respective of the computer program.

14. A computer-implemented method comprising:
inputting, by a computing system, performance data respective of a program into a machine learning model to cause the machine learning model to analyze the performance data for runtime errors;
receiving, from the machine learning model by the computing system, in response to the input of performance data, an indication of a runtime error respective of the computer program;
scanning, by the computing system, a codebase of the program to determine, based on the runtime error indication, a code location in the codebase related to the error;
inputting, by the computing system, the code location to the machine learning model to cause the machine learning model to generate one or more recommended remediation actions for the indicated runtime error;
receiving, by the computing system from the machine learning model, one or more remediation actions; and
causing, by the computing system, at least one of the one or more remediation actions to be implemented in response to the indication of the runtime error.

15. The computer-implemented method of claim 14, wherein the performance data comprises, with respect to a computing system executing the program, one or more of:
processor usage of the program;
memory usage of the program; or
network traffic related to the program.

16. The computer-implemented method of claim 14, wherein inputting the code location comprises copying code located at the code location and inputting the copied code.

17. The computer-implemented method of claim 16, wherein the received one or more remediation actions comprises a recommended revision to the copied code.

18. The computer-implemented method of claim 14, wherein the inputting is automatically performed periodically for each of a plurality of programs.

19. The computer-implemented method of claim 14, further comprising:
in response to receiving the indication of a runtime error, generating, by the computing system, a user-readable notification and causing the notification to be output to a user in a user interface;
receiving, from the user, via the user interface, a confirmation that remediation of the runtime error is desired;
wherein causing at least one of the one or more remediation actions to be implemented is further in response to the user confirmation.

20. The computer-implemented method of claim 14, further comprising:
in response to receiving the indication of a runtime error, determining that the error is or is not related to hardware infrastructure;
when the error is determined to be related to hardware infrastructure, generating an infrastructure-related prompt for the machine learning model to cause the machine learning model to generate one or more hardware infrastructure-related recommended remediation actions; and
when the error is determined not to be related to hardware infrastructure, retrieving data from one or more logs of the performance data and generating a prompt for the machine learning model based on the retrieved log data to cause the machine learning model to generate one or more code-related recommended remediation actions.
